(19) United States
(12) Patent Application Publication
(10) Pub. No.: US 2019/0017443 A1
(43) Pub. Date: Jan. 17, 2019

(54) RAPIDLY AVAILABLE ELECTRIC POWER FROM A TURBINE-GENERATOR SYSTEM HAVING AN AUXILIARY POWER SOURCE

(71) Applicant: Rolls-Royce North American Technologies, Inc., Indianapolis, IN (US)

(72) Inventor: Andrew J. Eifert, Indianapolis, IN (US)

(73) Assignee: Rolls-Royce North American Technologies, Inc., Indianapolis, IN (US)

(21) Appl. No.: 15/666,012

(22) Filed: Aug. 1, 2017

Related U.S. Application Data
(60) Provisional application No. 62/370,019, filed on Aug. 2, 2016.

(51) Int. Cl. F02C 7/32; F01D 15/10; F02C 6/14; F02C 7/36; F41H 13/00; H02P 9/02; H02P 9/06; H02S 10/10

(52) U.S. Cl. CPC F02C 7/32; F01D 15/10; F02C 6/14; F02C 7/36; F41H 13/0043; F05B 2240/60; H02P 9/06; H02S 10/10; F05D 2220/32; F05D 2220/76; H02P 9/02

(57) ABSTRACT

Turbine-generator systems having an auxiliary power source and methods of operating turbine-generator systems having auxiliary power sources in a high, intermittent load environment are provided. The turbine may be sized to meet substantially all the power required by the intermittent load. The auxiliary power source may have a power rating approximately equal to the power required to rotate the unloaded generator at an operational speed. The method may include decoupling the turbine from the generator, removing the load from the generator, coupling the auxiliary power source to the unloaded generator, and maintaining the operational rotational speed of the generator with the auxiliary power source.

### CROSS REFERENCE TO RELATED APPLICATION

This application claims priority to U.S. Provisional Patent Application No. 62/370,019, filed Aug. 2, 2016, the entirety of which is incorporated herein by reference.

### BACKGROUND

Many current electrical power generation solutions, such as turbine- and diesel-generators, have various advantages and disadvantages. For example, a turbine-generator system has a high power-to-weight ratio and power-to-volume ratio. However, turbine-generator systems tend to have a high specific fuel consumption and a low energy efficiency when the system is operated at idle or low-power levels. Additionally, a turbine-generator may require a longer ramp-up time until it can be loaded than other solutions. In comparison, a diesel-generator is capable of being started in a short period of time and can be more energy efficient at low power levels. However, a diesel-generator has a relatively low power-to-weight ratio and power densities.

Diesel-generators are commonly used in merchant ships and modern locomotives over turbine-generators because the of better energy efficiency, particularly at extended low power operations, and lower costs than offered by turbine-generator systems. Additionally, the design of ships and locomotives places a smaller premium on the minimization of the size and weight. In contrast, turbines and turbine-generators are commonly used on aircraft and other high-performance platforms where weight, size and power density are key design considerations.

The selection of an optimal electrical power generating solution for a given platform is further complicated by the dynamic operating requirements of the supported electrical load. Some loads, such as, e.g., a directed-energy weapon system, may be operated at low power levels for long periods that are interspersed with intermittent, high-power demands. These intermittent loads may require a rapid shift from low- to high-power operations with little or no warning. A diesel-generator may provide power during the long periods of low power demand but may be unable to provide the required high power output unless the diesel-generator is substantially oversized for the low power operations. While batteries may supplement high power requirements, they typically can only do so for a short period of time and require long periods to recharge. Additionally, batteries have a detrimental low power density, introduce toxic components and do not provide a solution for long-term high power operations.

A turbine-generator provides a higher power density, and therefore smaller size and weight than a diesel-generator, and may be better suited for high power operations. However, a turbine-generator will have a relatively low efficiency and high specific fuel consumption during long periods of operation at lower power. The size, weight and power advantages of a turbine may be outweighed by the potentially inefficient use of the turbine for extended periods in low power operations for a dynamic, intermittent load. Additionally, the high-power demand from the electrical load may be of sufficiently short notice that a turbine may be unable to ramp up to an operational condition, especially when subjected to the generator's inertia and electric load, before the high-power operations are required.

There remain challenges in supplying electrical power to a load which requires the capability to rapidly transition from low to high power operations with little or no warning while minimizing the fuel use and system weight.

In accordance with some embodiments of the present disclosure, a method of maintaining the operational rotational speed of a generator in a standby mode is presented. The method may be applied in a high, intermittent load environment wherein a gas turbine drives a generator to provide electrical power to an intermittent load. The gas turbine is sized to meet substantially all of the power required by the intermittent load. The method may include decoupling the gas turbine from the generator, removing the load from the generator, coupling an auxiliary power source to the unloaded generator, and maintaining the operational rotational speed of the generator with the auxiliary power source. The auxiliary power source may have a continuous maximum power rating which is approximately equal to the power required to rotate the unloaded generator at the operational rotational speed. The auxiliary power source may be an electrical power source such as an engine-driven generator, the electric power grid, a solar panel system, one or more capacitors (e.g., a bank of capacitors), one or more inductors (e.g., a bank of inductors), or one or more batteries (e.g., a bank of batteries). In some embodiments, the auxiliary power source is an auxiliary (or secondary) motor such as, e.g., a turbine engine, a diesel engine, a gasoline engine, and an electric motor, which is mechanically coupled to the generator shaft. The generator may be a motor-generator.

In accordance with some embodiments of the present disclosure, a method of transitioning between a standby mode and an active mode is provided. The method may be used on a system having a gas turbine, an auxiliary power source, a generator, and an intermittent load. The gas turbine is the primary driver of the generator and substantially satisfies the power requirements of the intermittent load in an active mode. The auxiliary power source satisfies the power requirement of the generator while unloaded and rotates the generator at an operational speed in the standby mode. The method may comprise engaging one of the gas turbine or auxiliary power source to the rotating the generator, disengaging the other of the gas turbine or the auxiliary power source from the rotating generator, and maintaining a minimum rotational speed between the transition. The method may comprise transitioning from an active to standby mode wherein the gas turbine is disengaged from and the auxiliary power source is engaged to the rotating generator. The method may include transitioning from the standby mode to the active mode in which the gas turbine in engaged to and the auxiliary power source in disengaged from the rotating generator.

In accordance with some embodiments of the present disclosure, a weapon system is provided. The weapon system may comprise a gas turbine, and auxiliary power source, a generator, and a directed-energy system. The gas turbine may be sized as the primary driver of the generator and substantially satisfies the peak power requirements of the directed-energy system. The auxiliary power system may satisfy the power requirement of the generator while unloaded and rotate the generator at an operational speed in a standby source.

These and many other advantages of the present subject matter will be readily apparent to one skilled in the art to which the disclosure pertains from a perusal of the claims, the appended drawings, and the following detailed description of preferred embodiments.

### BRIEF DESCRIPTION OF THE DRAWINGS

FIG. 1 is a diagram of a turbine-generator system.

FIG. 2 is a diagram of a turbine-generator system having an auxiliary power source in accordance with some embodiments of the present disclosure.

FIG. 3 is a diagram of a turbine-generator system having an auxiliary power source in accordance with some embodiments of the present disclosure.

FIG. 4 is a diagram of a turbine-generator system having an auxiliary power source in accordance with some embodiments of the present disclosure.

FIG. 5 is a diagram of a turbine-generator system having an auxiliary power source in accordance with some embodiments of the present disclosure.

FIGS. 6A and 6B are diagrams of a turbine-generator system having an auxiliary power source in accordance with some embodiments of the present disclosure.

FIG. 7 is a diagram of a turbine-generator system having an auxiliary power source in accordance with some embodiments of the present disclosure.

FIGS. 8A and 8B are flowcharts of the method of transitioning from active to standby mode, and standby to active mode, respectively, in accordance with some embodiments of the present disclosure.

FIG. 9 is a flowchart of a method of transitioning from standby to active mode in accordance with some embodiments of the present disclosure.

Referring to the drawings, some aspects of a non-limiting example of turbine-generator system having an auxiliary power source in accordance with an embodiment of the present disclosure are schematically depicted. In the drawings, various features, components and interrelationships therebetween of aspects of an embodiment of the present disclosure are depicted. However, the present disclosure is not limited to the particular embodiments presented and the components, features and interrelationships therebetween as are illustrated in the drawings and described herein.

### DETAILED DESCRIPTION

The objectives and advantages of the claimed subject matter will become apparent from the following detailed description of preferred embodiments thereof in connection with the accompanying drawings.

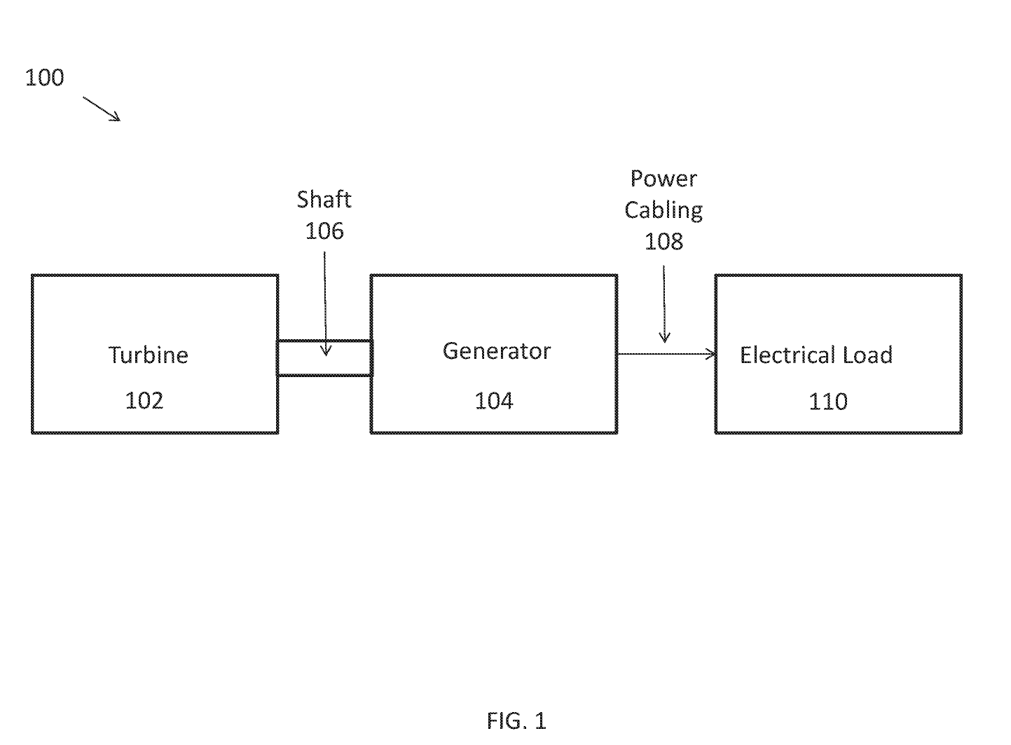

FIG. 1 illustrates a turbine generator system 100. The turbine generator system 100 comprises a turbine 102 and a generator 104. The rotation of the turbine causes rotation of the generator 104, which is mechanically coupled to the turbine 102 by shaft 106. The system 100 may further comprise a set of gears or other mechanical coupling that allows the turbine 102 and generator 104 to rotate at different speeds having a defined ratio between the speed of the turbine 102 and the speed of the generator 104.

The system 100 may further comprise electrical equipment that is capable of converting the electrical parameters of the electrical output of generator 104, such as, e.g., voltage, frequency, AC to DC, DC to AC, amperes, or any combination of the aforementioned, the electrical input into the electrical load 110, or both. This additional electrical equipment may be used in the embodiments present in this disclosure.

The turbine generator system 100 is sized in order to meet the peak electrical demands of electrical load 110. As used herein, the “sizing” of a turbine-generator system or other component refers to the selection of system having the operating characteristics and parameters capable of meeting the required demands of the system 100 including electrical load 110. Additionally, “sizing” may also refer to the selection of components which meet physical limits for a component such as a low weight and volume and other design characteristics.

The electrical load 110 may have operating requirements for which a turbine generator system is well suited, such as, e.g., a constant high electrical power demand. However, a turbine generator system may be less well suited if the electrical load 110 has widely varying power requirements because of the reduced efficiency and high specific fuel consumption of turbine-generators at low powers. While other electrical power generators, such as a diesel generator, may provide for improved fuel efficiencies at low powers, a diesel generator sufficiently sized to meet the high power, intermittent demands of load 110 may be unable to meet other system design requirements such as weight or volume limitations.

Turbine-generator system 100 is configured for operations in various modes such as, e.g., full-power operations (which may be referred to as a normal operating mode) and standby mode operations. During full-power operations the turbine generator system may be operating at or near its full power rating or its max efficiency point. Full-power operations may occur when the power demand from electrical load 110 is at or near its maximum or when there are indications that a power demand of this level may be required at some point in the near future. In standby mode, the system 100 supplies no electric power to load 110 or a power level significantly below that of full-power operations. In embodiments, the standby mode is used to primarily maintain the rotation of generator 104 near an operational speed in order to facilitate a more rapid transition from the standby mode to full-power operations.

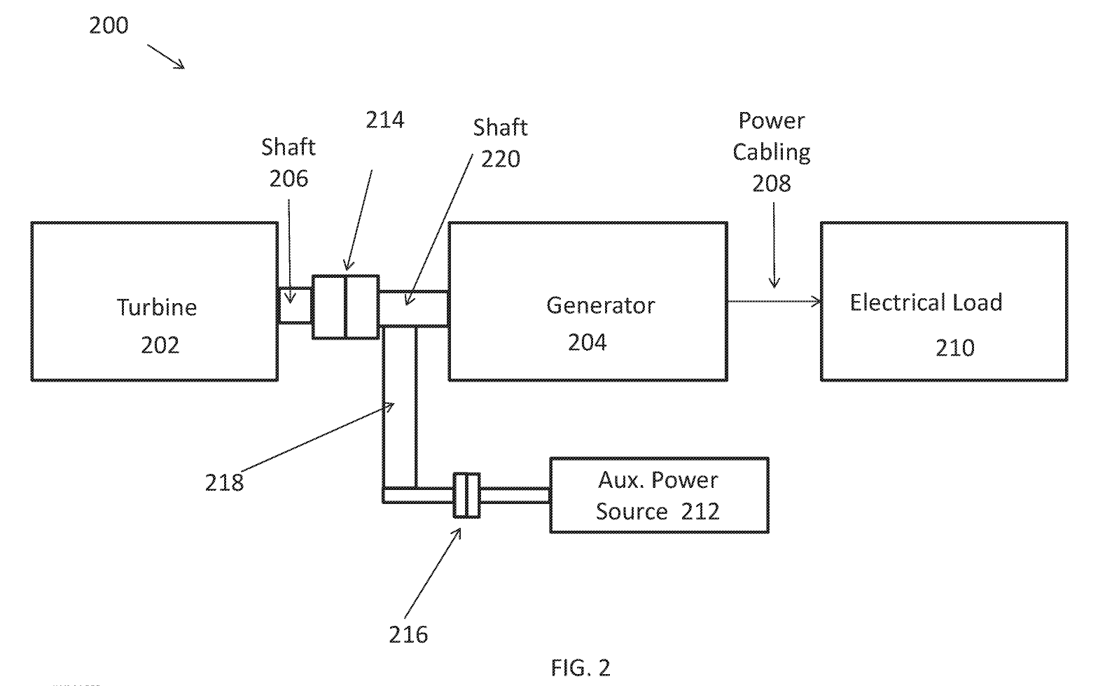

In accordance with embodiments of the present disclosure, a turbine generator system 200 having an auxiliary power source 212 is illustrated in FIG. 2. The turbine generator system 200 comprises a turbine 202 that may be mechanically coupled to the generator 204. The system 200 further comprises shaft 206, power cabling 208, load 210, an auxiliary power source 212, mechanical coupling devices 214, 216, and 218, and generator shaft 220.

During normal, full power operations the turbine 202 is mechanically coupled to the generator 204 by turbine shaft 206, mechanically coupling device 214 and generator shaft 220. The gas turbine's 202 rotational energy is transferred into the generator 204 that converts the rotational energy into electrical current to supply power to the electrical load 210 via electrical power cabling 208. Turbine 202, generator 204, shaft 206, cabling 208 and electric load 210 may comprise the various features described above for turbine 102, generator 104, shaft 106, cabling 108, and electric load 110, respectively. System 200 may be capable of operating in the modes described above for system 100.

Mechanical coupling device 214 is used to connect and disconnect the turbine shaft 206 to the generator shaft 220. The coupling of the turbine 202 and generator 204 is generally a function of the operating mode of the generator system 200. During normal, full-power operations, mechanical coupling device 214 (typically a clutch) will operate to mechanically couple turbine 202 and generator 204. During standby mode, mechanical coupling device 214 operates to decouple turbine 202 from generator 204. Mechanical coupling device 214 may be a clutch of any type such as, e.g., a one-way clutch, a friction clutch, centripetal, wet, dry etc., although the embodiments of this disclosure are not so limited.

In standby mode, the generator 204 and generator shaft 220 are maintained at an operational, standby speed while no electrical load or a minimal electrical load is required by electrical load 210. The operational, standby speed is maintained by the auxiliary power source 212 which is mechanically coupled to the generator 204 and generator shaft 220 through mechanical coupling devices 216 and 218.

The auxiliary power source 212 may be any device capable of causing generator 204 to rotate such as, for example and without limitation, a turbine engine, a diesel engine, a gasoline engine, or an electrical motor. As used herein, the term motor refers to an electric motor and an engine refers to a combustion device. Both a motor and an engine are capable of being configured to cause rotation of the objects such as, e.g., generator 204, and the terms “motor” and “engine” may be used interchangeably as determined by the context in which they are used. In some embodiments the auxiliary power source 212 may have a continuous maximum power rating which is approximately equal to the power required to rotate the generator 204 and shaft 220 in the standby mode and any minimal electrical load required by load 210.

Mechanically coupling device 216 is used to connect and disconnect the auxiliary power source 212 from the generator 204 when the generator 204 is operating in a standby and normal full-power mode, respectively. Mechanically coupling device 216 may be any type of clutch system as described previously. Mechanical coupling device 218 may comprise gears or other mechanical connection techniques to couple the auxiliary power source 212 to the generator 204 and defines at least in part one or more speed ratios between the rotational speed of the generator 204 and the speed of the auxiliary power source 212.

In some embodiments, the maximum power rating of turbine 202 may be insufficient to drive generator 204 to provide the maximum power demanded by electrical load 210. The system 200 may be configured such that auxiliary power source 212 and the turbine 202 may both be simultaneously coupled to the generator 204. The additional power supplied by auxiliary power source 212 may supplement the power provided by turbine 202 such that their combined power output satisfies the power demands of electrical load 210.

The standby operational speed of generator 204 may be chosen such that the generator produces the minimal electrical power input at a particular frequency or other electrical parameter as required by electrical load 210 while in a standby mode. In some embodiments, the standby operational speed of generator 204 is chosen such that it matches the operational speed required by the system 200 when it is operated at full-power. By maintaining the generator 204 at this speed, the system may be capable of reaching a point wherein full-power operations may be indefinitely maintained more quickly because only the turbine 202 is required to be spun up to the operational speed. Typically, turbines are low inertia devices and unloaded ramp up quickly.

In some embodiments, the standby operational speed of the generator 204 may be chosen to maximize the rotational energy of the generator 204 and generator shaft 220. Rotating the generator 204 at a non-zero speed allows the kinetic energy of the generator 204, stored as angular momentum, to act as a mechanical battery and for the system 200 to more rapidly respond to a short or no-notice electrical demand. The kinetic energy stored by this mechanical battery may be converted to electrical power to supply electrical load 210 for a short- or no-notice demand for some limited period of time. In a preferred embodiment, the rotational kinetic energy stored in the generator 204 is sufficient to supply the electrical power demands of electrical load 210, which may be at or near the full-power demand of load 210, until the turbine 202 is brought up to or near its normal operational speed. Further, the operational speed of the generator 204 in standby mode may be capable of not only supporting the full-power, limited duration operation of load 210 but may be selected to be higher than that required for full power operation such that the extraction of kinetic energy reduces the angular momentum, thus slowing of generator 204, such that the reduced rotational speed of generator 204 matches, approaches, or otherwise becomes closer to the operational speed of generator 204 when it is mechanically coupled to the turbine 202 during normal, full-power operations.

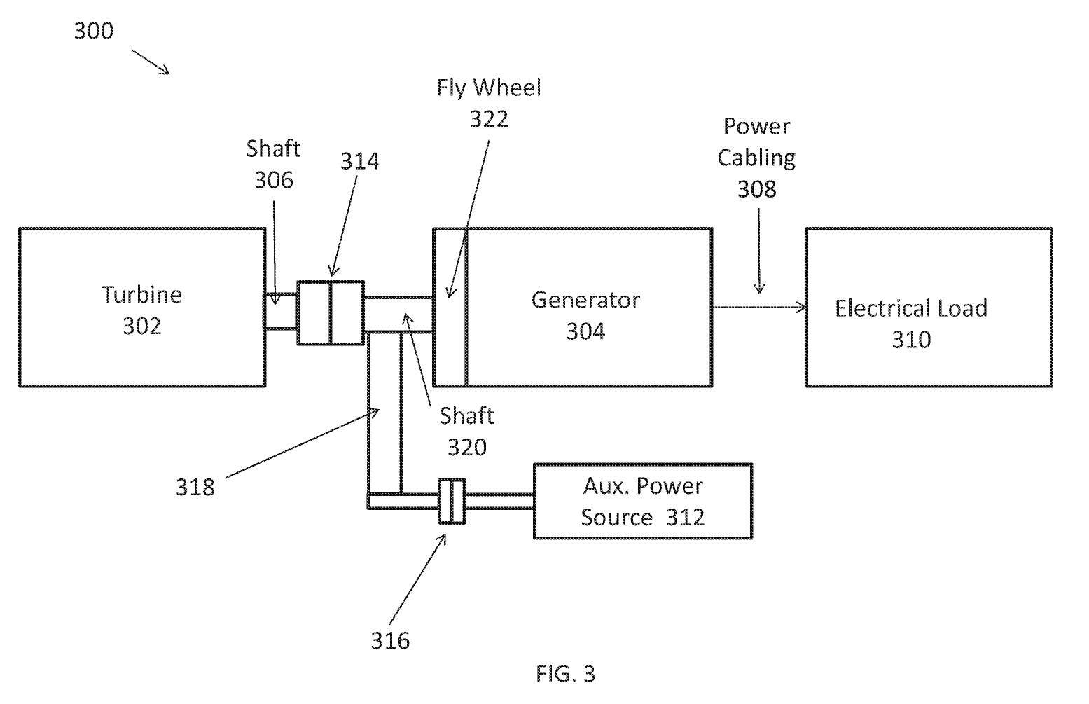

In accordance with some embodiments of the present disclosure, a turbine-generator system 300 having an auxiliary power source 312 is presented in FIG. 3. Turbine generator system 300 may comprise turbine 302, shaft 306, mechanical coupling device 314, generator shaft 320, generator 304, power cabling 308, electrical load 310 mechanical coupling device 318, mechanical coupling device 316 and auxiliary power source 312. Turbine 302, generator 304, electrical load 310, auxiliary power source 312, shaft 306 and 320, mechanical coupling device 314, power cabling 308, mechanical coupling device 316, and mechanical coupling 318 may comprise features and characteristics similar to those described above for turbine 102 and 202, generator 104 and 204, electrical load 110 and 210, auxiliary power source 212, shaft 106, 206 and 220, mechanical coupling device 214, power cabling 108 and 208, mechanical coupling device 216, and mechanical coupling device 218, respectively. System 300 may be capable of operating in the modes described above for systems 100 and 200.

The turbine generator system 300 may further comprise flywheel 322. Flywheel 322 functions as an inertia device in order to increase the inertia of the generator 304 system and thus its ability to store kinetic energy as angular momentum. By adding mass to the generator 304, shaft 320, or both, the rotational kinetic energy of the rotating components in standby mode may be increased over a system having a lower moment of inertia for a given angular velocity, thereby allowing the system to supply either more power or a given power level over a longer period of time. Increasing the system moment of inertia using a flywheel also functions to reduce the decrease in angular momentum when energy is extracted to provide electrical energy to the load 310. The flywheel 322 may be built into the generator 304 as an integral component or may be located externally to the generator 304. Moreover, the flywheel 322 may also be selectively coupled to the generator via a mechanical means such as a clutch as described previously. After operational rotational speed of the generator 304 has been achieved and the turbine 302 is connected to the generator 304, the flywheel 322 may be uncoupled from the generator 304 to avoid the energy drain from turbine 302 associated with rotating the flywheel 322 and the auxiliary power source 312.

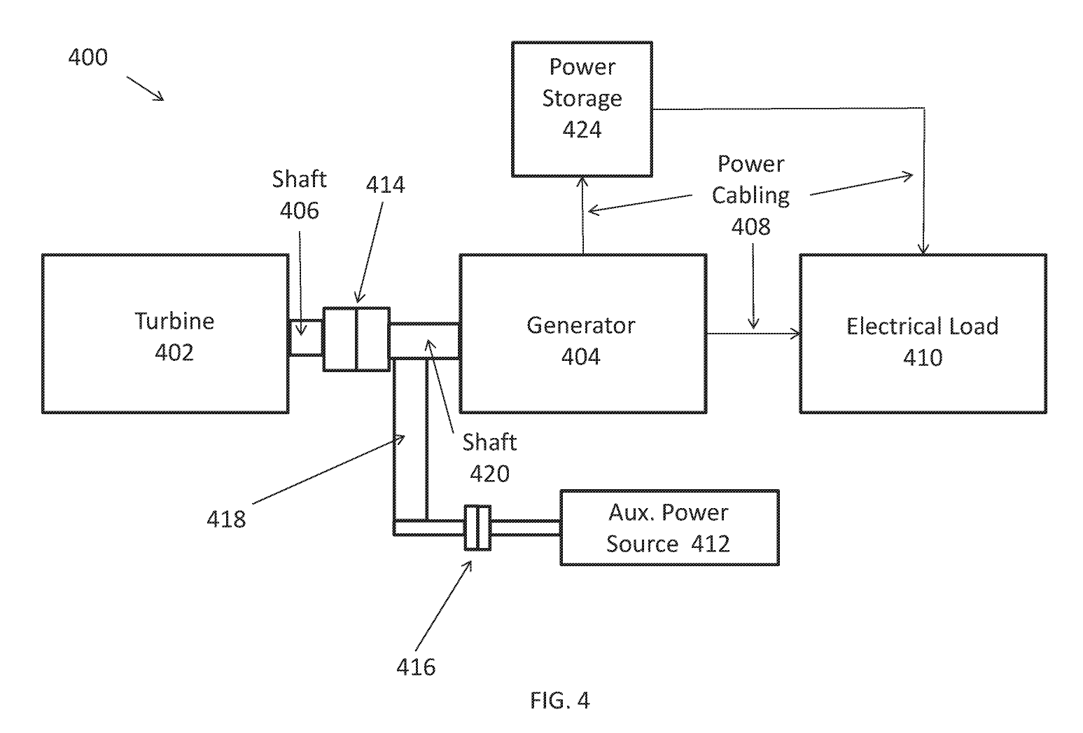

In accordance with some embodiments of the present disclosure, a turbine generator system 400 having an auxiliary power source 412 is illustrated in FIG. 4. The system 400 may comprise a turbine 402, shaft 406, mechanical coupling device 414, shaft 420, generator 404, power cabling 408, electrical load 410, mechanical coupling device 418, mechanical coupling device 416, and auxiliary power source 412. Turbine 402, generator 404, electrical load 410, auxiliary power source 412, shafts 406 and 420, mechanical coupling device 414, power cabling 408, mechanical coupling device 416, and mechanical coupling 418 may comprise features and characteristics similar to those described above for turbine 102, 202 and 302, generator 104, 204 and 304, electrical load 110, 210 and 310, auxiliary power source 212 and 312, shaft 106, 206 and 306 and 220 and 320, mechanical coupling device 214 and 314, power cabling 108, 208 and 308, mechanical coupling device 216 and 316, and mechanical coupling device 218 and 318, respectively. System 400 may be capable of operating in the modes described above for systems 100, 200 and 300. In some embodiments the system 400 may further comprise a flywheel (not shown) which may comprise features similar to those described above for flywheel 322.

Turbine generator system 400 may further comprise a power storage system 424 and additional electrical cabling 408 between the generator 404 and power storage system 424, and between the power storage system 424 and the electrical load 410. Power storage system 424 may comprise a bank of capacitors, a bank of inductors, flywheels, batteries, or any other form of electrical power storage system. Cabling 408 located between the generator 404 and the power storage system 424 allows electricity generated by generator 404 to replenish or recharge the power storage system 424 regardless of whether the generator 404 is being rotated by the turbine 402 or the auxiliary power source 412. The cabling 408 located between the power storage system 424 and the electrical load 410 provides the ability for the power storage system 424 to provide the electrical power needed to operate the electrical load 410 in response to a short- or no-notice demand for some period of time. The power supplied to electrical load 410 during this short- or no-notice demand may be supplied by the generator 404, using the energy stored in its operational rotation in standby mode, simultaneously with the power storage system 424, before or after the power storage system 424, or any combination of these options.

The power storage system 424 may provide the ability to meet higher electrical power demands or the same power demand for a longer period than a turbine generator system 400 having an auxiliary power source 412 without a power storage system 424 when the system 400 is in a standby mode. In some embodiments, the power storage system 424 may be capable of providing the total electrical power and energy required by electrical load 410 in response to the short or no notice demand. In this embodiment, the generator 404 need not slow during a transition from standby to full-power operations and the electrical load 410 is still supplied with some power level greater than that which may be supplied during standby operations. This operating capability may provide for the turbine 402 and generator 404 to begin normal, full-power operations more quickly than in an embodiment the generator 404 is slowed while acting as a mechanical battery.

In some embodiments the auxiliary power source 412 may have a power rating sufficient to not only maintain the rotation of generator 404 at an operational speed but additionally to support some charging of the power storage system 424 through the rotation of the generator 404.

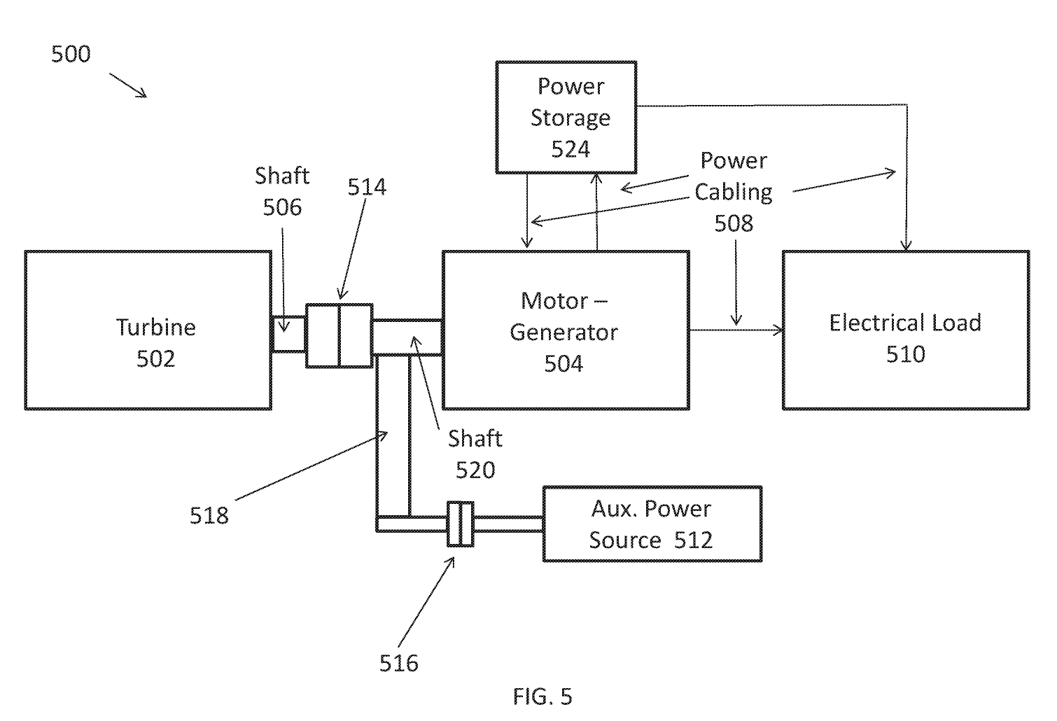

In accordance with some embodiments of the present disclosure, a turbine generation system 500 having an auxiliary power source 512 is presented in FIG. 5. The system 500 may comprise a turbine 502, shaft 506, mechanical coupling device 514, shaft 520, electrical load 510, mechanical coupling device 518, mechanical coupling device 516, auxiliary power source 512, and power storage system 524. Turbine 502, electrical load 510, auxiliary power source 512, shafts 506 and 520, mechanical coupling device 514, power cabling 508, mechanical coupling device 516, mechanical coupling 518, and power storage system 524 may comprise features and characteristics similar to those described above for turbine 102, 202, 302 and 402, electrical load 110, 210, 310 and 410, auxiliary power source 212, 312 and 412, shaft 106, 206, 306 and 406 and 220, 320 and 420, mechanical coupling device 214, 314 and 414, power cabling 108, 208, 308 and 408, mechanical coupling device 216, 316 and 416, mechanical coupling device 218, 318 and 418, and power storage system 424 respectively. System 500 may be capable of operating in the modes described above for systems 100, 200, 300 and 400. In some embodiments the system 500 may further comprise a flywheel (not shown) which may comprise features similar to those described above for flywheel 322.

The generator of system 500 may be a motor-generator 504. The motor generator 504 may be driven by the turbine 502, auxiliary power source 512, the motor portion of motor-generator 504, or any combination of the foregoing depending on the mode of operation of system 500. The motor-generator 504 may be supplied with electrical power from the power storage system 524 when operating as an electrical motor. The power storage system 524 may be configured to provide electrical power to the electrical load 510 in response to a short- or no-notice electrical demand, either in conjunction with or separately from the motor-generator 504, as well as supplying electrical power of the motor-generator 504 to maintain the generator at a designed operational speed. This embodiment may allow for the intermittent operation of the auxiliary power source 512 to maintain the rotational speed of the motor-generator 504, recharge the power storage system 524 thorough the motor generator 504, or both.

In some embodiments, the motor function of motor-generator 504 may be replaced with a generating unit that is mechanically coupled to an auxiliary electric motor (not shown). The auxiliary motor may be supplied with electrical power from the power storage system 524 in order to maintain the operational rotation of the generator 504 during periods in which the auxiliary power source 512 is not operating.

The generator characteristics of motor-generator 504 may resemble the characteristics of generators 104, 204, 304 and 404.

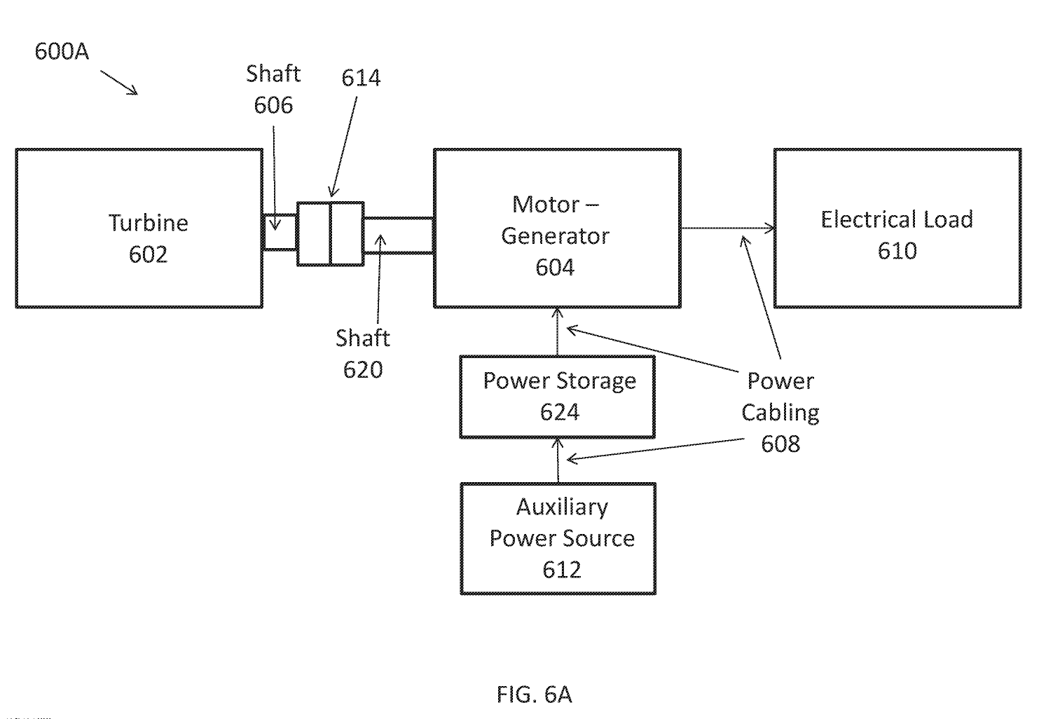

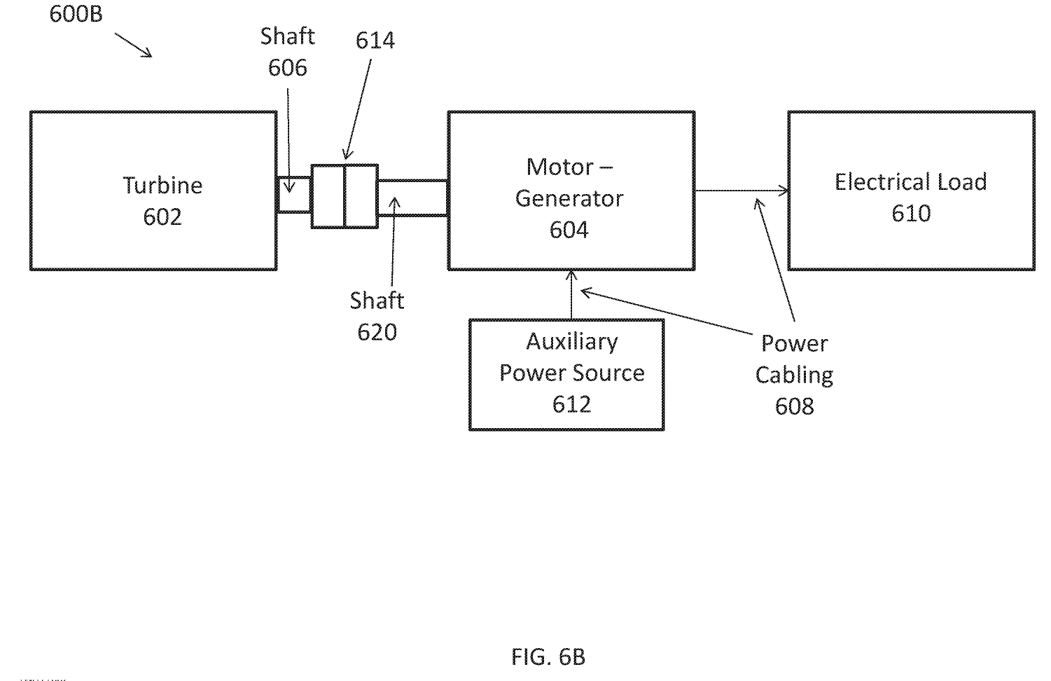

In accordance with some embodiments of the present disclosure, a turbine generator system 600A having an auxiliary power source 612 is provided in FIG. 6A. The system 600 may comprise a turbine 602, shaft 606, mechanical coupling device 614, shaft 620, motor-generator 604, electrical load 610, auxiliary power source 612, and power storage system 624. Turbine 602, motor-generator 604 electrical load 610, shafts 606 and 620, power cabling 608, mechanical coupling device 614 and power storage system 624 may comprise features and characteristics similar to those described above for turbine 102, 202, 302, 402 and 502, motor-generator 504, electrical load 110, 210, 310, 410 and 510, shaft 106, 206, 306, 406 and 506 and 220, 320, 420 and 520, power cabling 108, 208, 308, 408 and 508, mechanical coupling device 214, 314, 414 and 514, and power storage system 424 and 524, respectively. System 600 may be capable of operating in the modes described above for systems 100, 200, 300, 400 and 500. In some embodiments the system 600 may further comprise a flywheel (not shown) which may comprise features similar to those described above for flywheel 322.

The auxiliary power source 612 of system 600 may provide a source of electrical power to the power storage system 624 through power cabling 608. In turn, the power storage system 624 may provide this electrical power to the motor generator 604. In some embodiments, auxiliary power source 612, power storage system 624, or both may be directly connected to the electrical load 610.

The auxiliary power source 612 may be an engine driving generator, such as, e.g., a diesel or gasoline powered generator, the electrical grid, a solar panel system, a bank of capacitors, a bank of inductors, a bank of batteries, flywheel generators, or a combination of these systems.

During standby operations the auxiliary power source 612 provides power to recharge the power storage system 624. The auxiliary power source 612 further supplies the power to rotate the motor-generator 604 at an operational speed either directly or through the power storage system 624. When a short- or no-notice electrical demand is required by the electrical load, the power storage system 624 may supply the required electrical power either directly to the electrical load 610 or by driving the motor of motor-generator 604 in order to generate the electrical power. In some embodiments, the power supplied to the electrical load 610 by the power storage system 624 may be supplemented by the auxiliary power source 612. Additionally, the rotational kinetic energy of the motor-generator 604 may act as a mechanical battery which can provide power to the electrical load 610, along with the power storage system 624, auxiliary power source 612, or both, for some period of time while the turbine 602 is being brought up to speed. Once the turbine 602 is capable of supporting a load, the turbine 602 is coupled to the motor-generator 604 by shaft 606, mechanical coupling device 614 and shaft 620. The turbine 602 then provides the rotational energy to be converted by the generator portion of motor-generator 604 to supply the electrical load 610 in the normal operating mode.

In accordance with some embodiments of the present disclosure, a turbine-generator system 600B having an auxiliary power source 612 is illustrated in FIG. 6B. System 600B comprises components disclosed in and may operate in a manner similar to system 600A. However, the power storage system 624 of system 600A has been removed from 600B, and the modes of system 600A requiring a power storage system, 624 are therefore not achievable by system 600B.

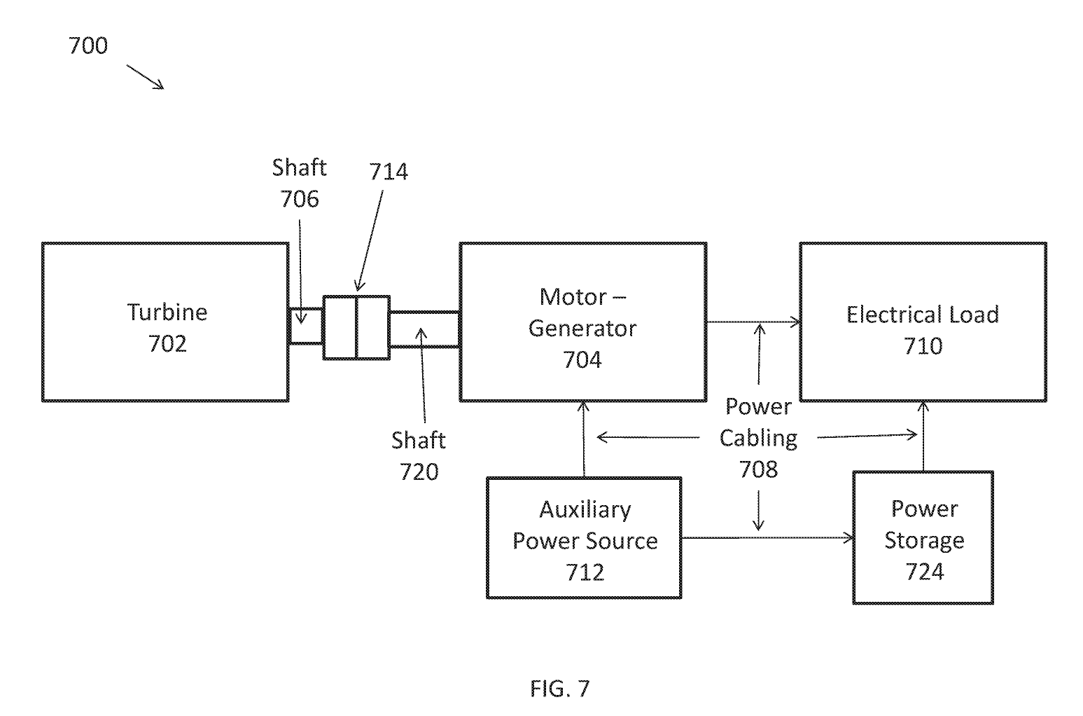

In accordance with some embodiments of the present disclosure, a turbine generator system having an auxiliary power source 712 is illustrated in FIG. 7. The system 700 may comprise a turbine 702, shaft 706, mechanical coupling device 714, shaft 720, motor-generator 704, electrical load 710, auxiliary power source 712, and power storage system 724. The turbine 702, shaft 706, mechanical coupling device 714, shaft 720, motor-generator 704, auxiliary power source 712, power cabling 708, power storage system 724, and electrical load 710 may comprise features similar to those described above for turbine 102, 202, 302, 402, 502 and 602, shaft 106, 206, 306, 406, 506 and 606, mechanical coupling device 214, 314, 414, 514 and 614, shaft 220, 320, 420, 520 and 620, motor-generator 504 and 604, auxiliary power source 612, power cabling 108, 208, 308, 408, 508 and 608, power storage system 424, 524 and 624, and electrical load 110, 210, 310, 410, 510 and 610, respectively. System 700 may be capable of operating in the modes described above for systems 100, 200, 300, 400, 500 and 600. In some embodiments the system 700 may further comprise a flywheel (not shown) which may comprise features similar to those described above for flywheel 322.

The auxiliary power source 712 of system 700 may provide a source of electrical power to the power storage system 724 and to the motor-generator 704 through separate power cablings 708. Power storage 724 may provide electrical power to electrical load 710 during the standby mode, a transition from the standby mode to normal mode, normal mode, or all three. Additionally, the rotational speed of the motor-generator 704 may be maintained in the standby mode by the auxiliary power source 712. The rotation motor-generator 704 may be used to both decrease time until the turbine-generator system 700 is capable of supporting the load 710 in normal mode and to cause the motor-generator 704 to function as a mechanical battery capable of supporting the electrical load 710 in response to a short- or no-notice demand while the system is operating standby mode. In some embodiments, the motor-generator 704, the power storage 724, or both may provide power to the electrical load 710 in response to the short notice loading. In some embodiments, the turbine 702, auxiliary power source 712 (through motor-generator 704, power storage system 724, or both), and the power storage system 724 may simultaneously supply power to the electrical load 710 during normal, full power operations.

In accordance with some embodiments of the present disclosure, a method of maintaining the operational rotational speed of a generator in a standby mode is provided. The method may include removing an electrical load from the generator, decoupling a gas turbine from the generator, and coupling an auxiliary power source to the unloaded generator. In some embodiments, the method may further include loading the generator after it has been coupled to the auxiliary power source. The method may further include supplying electrical power from the auxiliary power source to operate the generator as a motor.

In accordance with some embodiments of the present disclosure, a method of transitioning a turbine-generator system having an auxiliary power source between a standby and an active mode is provided. The method may comprise engaging either the turbine or the auxiliary power source to a rotating generator and disengaging the other of the turbine or the auxiliary power source from the rotating generator. The method may further comprise maintaining a minimum rotational speed of the generator during the transition from the standby to active mode. The minimum rotational speed to be maintained is a function of the generator output, intermittent load, duration of the transitions between active and standby modes, and the direction of transitions (active to standby or standby to active).

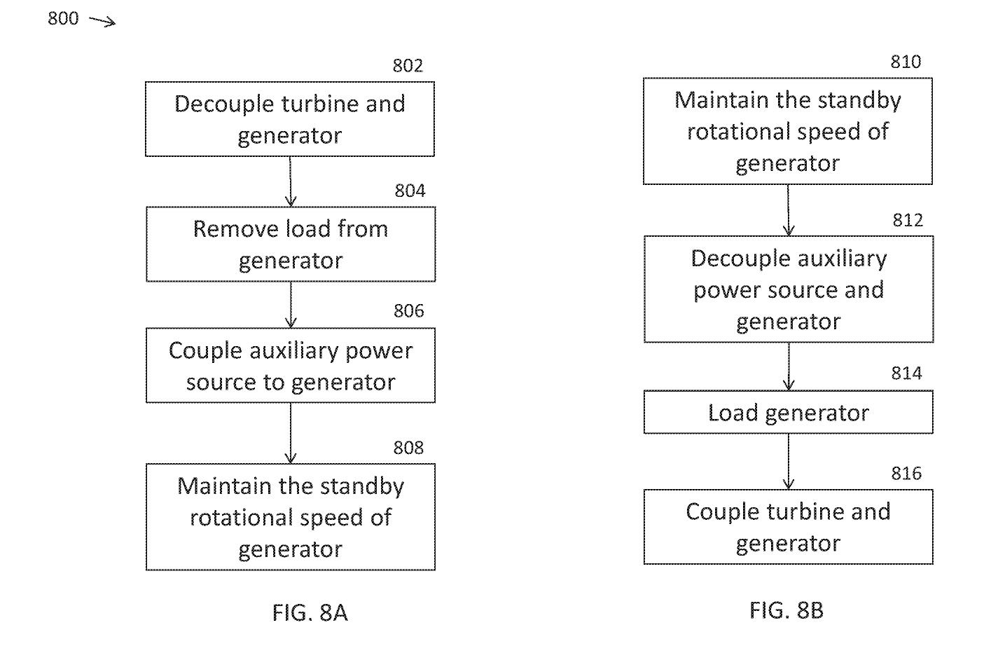

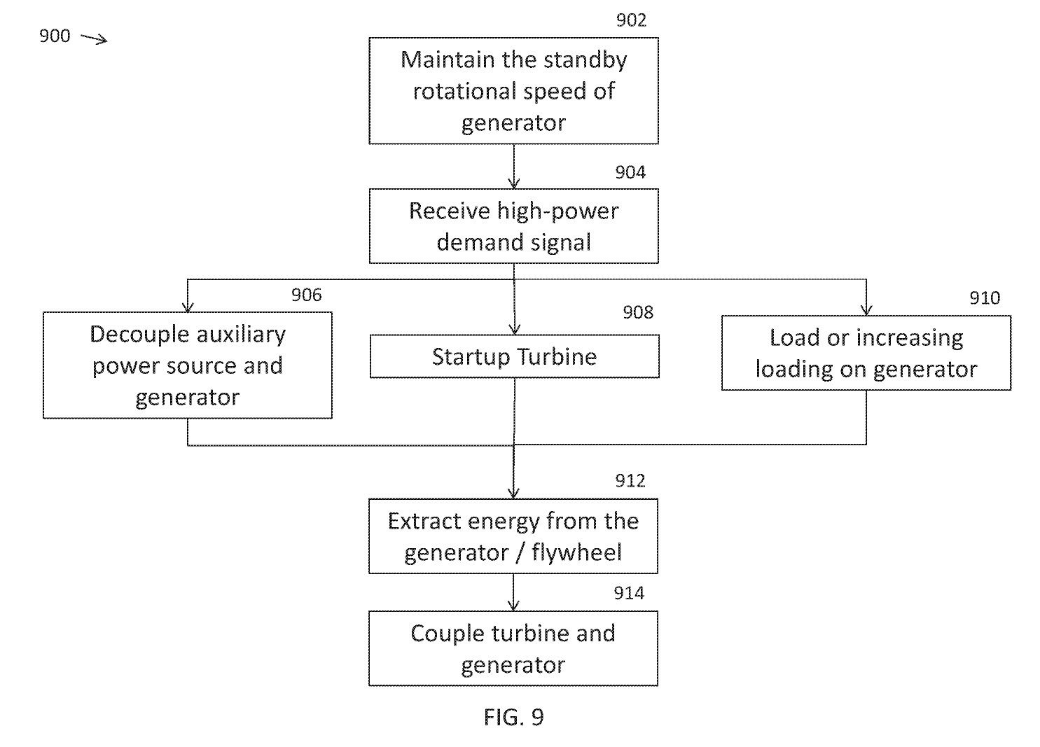

In accordance with some embodiments of the present disclosure, a method 800 of transitioning from an active to a standby mode, and from a standby to an active mode, is presented in FIGS. 8A and 8B, respectively. Prior to Box 802, the turbine-generator system is operating in an active mode. At Box 802 of FIG. 8A, the turbine and generator are mechanically decoupled. At Box 804, the electrical load is removed from the generator. The particular order of boxes 802 and 804 may change depending on the desired operation of the turbine-generator system. Decoupling the turbine from the generator while the electrical load is still placed on the generator will cause the generator to slow as energy is extracted. If this slowing is not desired, the electrical load may be removed from the generator before the turbine and generator are decoupled. At Box 806, the auxiliary power source is mechanically coupled to the generator. After the auxiliary power source is coupled to the generator, the auxiliary power source maintains the standby, operational rotational speed of the generator at Box 808.

In some embodiments, the turbine and auxiliary power source may both be simultaneously connected to the generator in the active mode in order to meet the power demands of an electrical load. In these embodiments, transitioning from the active to standby mode may require only decoupling the turbine and removing the load from the generator. The auxiliary power source remains coupled to generator after the load has been removed. In some embodiments, a small load may remain or be placed on the generator after only the auxiliary power source is coupled to the generator.

While the system is operated in standby mode, the operational rotational speed of the generator is maintained by the auxiliary power source at Box 810. The turbine-generator system may be subjected to an increased electrical load with little-to-no notice, in which case the system may be capable of providing for this increased electrical load for some duration as described above until the system is capable of operating in the active mode. To transition into active mode, the auxiliary power source may be decoupled from the generator at Box 812. At Box 814 the generator, which is rotating at its operational standby speed, may be loaded in order to provide the short-notice electrical loading while the generator is speeding up. As the generator supplies this loading the generator will slow until the turbine and generator are coupled at Box 816.

As described above, the auxiliary power source may remain coupled to the generator while the short-notice electrical loading is applied. In some embodiments, the auxiliary power source may remain coupled while the turbine is coupled to the generator to enter the active mode.

In accordance with some embodiments of the present disclosure, a method 900 of transitioning a turbine generator system having an auxiliary power source from a standby to an active mode is presented. The method begins at Box 902 in which the system is in a standby mode and the generator is maintained at an operational, standby rotational speed by the auxiliary power source. As described above, the operational, standby speed of the generator may be a speed higher than the active full-power speed of the generator, this higher speed may be used in order to maximize the rotational energy stored by the generator system. The standby rotational speed may be any speed selected as determined by the factors discussed above. At Box 904 the system receives or senses an increased electrical power demand signal. This increase in load may be up to and including the full-power loading. For example, for a directed energy weapon system, the demand signal may indicate that the weapon system needs to be fired. In response to this demand signal, the auxiliary power source may be decoupled from the generator at Box 906, the turbine may be started at Box 908, and the load may be placed on or the loading on the generator increased at Box 910. The events in Boxes 906, 908, and 910 may occur simultaneously or nearly simultaneously. In some embodiments one or more of events may occur either before or after the other events. For example, the auxiliary power source may be decoupled from the generator prior to loading, or increasing the loading on the generator. In some embodiments, the auxiliary power source may not be decoupled from the generator and Box 906 is optional. In some embodiments the auxiliary power source may be decoupled after the turbine is coupled to the generator, or both the auxiliary power source and the turbine may be simultaneously coupled to the generator.

The generator may begin to slow as the load is applied or increased on the generator as energy is extracted from the rotational energy of the generator, flywheel, or both and is converted into electrical power at Box 912. The generator may slow regardless of the whether the auxiliary power source remains coupled to the generator because the high-power loading may be greater than the power output of the auxiliary power source. At some point after the generator begins to slow, the turbine will reach a point at which it can be loaded. At Box 914, the turbine will be coupled to the generator and the system enters an active, full-power mode.

An aspect of the current subject matter is the ability to decrease turbine ramp-up time by keeping the turbine unloaded until it is substantially up to its preferred operational speed. Another aspect is the ability to extract rotational energy from the generator/flywheel to provide electric power until the turbine is up to speed.

While preferred embodiments of the present disclosure have been described, it is to be understood that the embodiments described are illustrative only and that the scope of the disclosure is to be defined solely by the appended claims when accorded a full range of equivalence. Many variations and modifications naturally occurring to those of skill in the art from a perusal hereof.

I claim:

1. In a high intermittent load environment, wherein a gas turbine drives a generator to provide power to an intermittent load and the gas turbine is sized to meet substantially all the power required by the intermittent load, a method of maintaining an operational rotational speed of the generator in a standby mode, comprising:
decoupling the gas turbine from the generator;
removing the load from the generator;
coupling an auxiliary power source to the unloaded generator; and
maintaining the operational rotational speed of the generator with the auxiliary power source, wherein the auxiliary power source has a continuous maximum power rating approximately equal to power required to rotate the unloaded generator at the operational rotational speed.

2. The method of claim 1, wherein the auxiliary power source is an electric power source.

3. The method of claim 2, further comprising:
supplying electrical power from the electric power source to the generator; and
operating the generator as a motor.

4. The method of claim 2, further comprising:
supplying electrical power from the electric power source to a secondary motor; and
rotating the unloaded generator with the secondary motor.

5. The method of claim 2, wherein the electric power source is selected from the group consisting of an engine driven generator, an electric grid, a solar panel system, one or more capacitors, one or more inductors, and one or more batteries.

6. The method of claim 1, wherein the auxiliary power source is an auxiliary motor mechanically coupled to a shaft of the generator.

7. The method of claim 6, wherein the auxiliary motor is mechanically coupled to the generator shaft via a clutch.

8. The method of claim 6, wherein the auxiliary motor is selected from the group consisting of a turbine engine, a diesel engine, a gasoline engine, and an electric motor.

9. In a system having a gas turbine, an auxiliary power source, a rotating generator and an intermittent load, wherein the gas turbine is the primary driver of the generator and substantially satisfies the power requirements of the intermittent load in an active mode, and wherein the auxiliary power source satisfies a power requirement of the generator while unloaded and rotates the generator at operational speed in a standby mode, a method of transitioning between the standby mode and the active mode, comprising:
engaging one of the gas turbine or auxiliary power source to the rotating generator,
disengaging the other of the gas turbine or auxiliary power source from the rotating generator;
and maintaining a minimum rotational speed between the transition.

10. The method of claim 9, wherein during the transition from the active mode to the standby mode, the gas turbine is disengaged from the rotating generator and the auxiliary power source is engaged to the rotating generator.

11. The method of claim 9, wherein during the transition from the standby mode to the active mode, the gas turbine is engaged to the rotating generator and the auxiliary power source is disengaged from the rotating generator.

12. The method of claim 9, wherein the minimum rotational speed is a function of the generator output, intermittent load, transition duration and direction of transition.

13. The method of claim 12, wherein the minimum rotational speed for a transition from standby mode to the active mode is less that the standby operational speed.

14. The method of claim 12, wherein the minimum rotational speed for a transition from active mode to standby is less that the standby operational speed and active operational speed.

15. The method of claim 9, wherein the gas turbine or auxiliary power source is engaged via a clutch.

16. The method of claim 9, wherein the auxiliary power source is engaged or disengaged via an electrical connection.

17. A weapon system comprising:
a gas turbine,
an auxiliary power source,
a generator having a shaft; and
a directed-energy system;
wherein the gas turbine is sized as the primary driver of the generator and substantially satisfies the peak power requirements of the directed-energy system; and, wherein the auxiliary power source satisfies the power requirement of the generator while unloaded and rotates the generator at an operational speed in a standby mode.

18. The system of claim 17, wherein the auxiliary power source is an electric power source.

19. The system of claim 17, wherein the auxiliary power source is an auxiliary motor mechanically coupled to the generator shaft via a clutch.

20. The system of claim 19 wherein the auxiliary motor is selected from the group consisting of a turbine engine, a diesel engine, a gasoline engine, and an electric motor.
